(19) United States
(12) Patent Application Publication
(10) Pub. No.: US 2026/0107242 A1
(43) Pub. Date: Apr. 16, 2026

(54) TECHNIQUES FOR ON-DEMAND SYNCHRONIZATION SIGNAL BLOCK (SSB) OPERATIONS

(71) Applicant: QUALCOMM Incorporated, San Diego, CA (US)

(72) Inventors: Hung Dinh LY, San Diego, CA (US); Stefan BRUECK, Neunkirchen am Brand (DE)

(21) Appl. No.: 19/349,748

(22) Filed: Oct. 3, 2025

Related U.S. Application Data
(60) Provisional application No. 63/707,050, filed on Oct. 14, 2024.

(51) Int. Cl. H04W 56/00; H04W 8/22; H04W 24/08

(52) U.S. Cl. CPC H04W 56/0015; H04W 8/22; H04W 24/08

(57) ABSTRACT

Aspects of the present disclosure relate to wireless communications, and more particularly, to techniques for synchronization signal block (SSB) communications. One aspect provides a method for wireless communication at a user equipment (UE). The method includes transmitting, to a network entity, capability information indicating a parameter for determining a first time period associated with a synchronization signal block (SSB) transmission; receiving, from the network entity, an indication of the SSB transmission; and monitoring for the SSB transmission to receive one or more SSBs in accordance with the indication, wherein the one or more SSBs are to be received at a time instance that is after at least the first time period following receiving the indication.

### CROSS-REFERENCE TO RELATED APPLICATION

This application claims benefit of and priority to U.S. Provisional Application No. 63/707,050 filed Oct. 14, 2024, which is hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for synchronization signal block (SSB) communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, further improvements in wireless communications systems may be made to overcome the aforementioned technical challenges and others.

### SUMMARY

One aspect provides a method for wireless communication at a user equipment (UE). The method includes transmitting, to a network entity, capability information indicating a parameter for determining a first time period associated with a synchronization signal block (SSB) transmission; receiving, from the network entity, an indication of the SSB transmission; and monitoring for the SSB transmission to receive one or more SSBs in accordance with the indication, wherein the one or more SSBs are to be received at a time instance that is after at least the first time period following receiving the indication.

Another aspect provides a method for wireless communication at a network entity. The method includes receiving, from a user equipment (UE), capability information indicating a parameter for determining a first time period associated with a synchronization signal block (SSB) transmission; transmitting, to the UE, an indication of the SSB transmission; and transmitting one or more SSBs in accordance with the indication, wherein the one or more SSBs are to be transmitted at a time instance at least the first time period following transmitting the indication.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example diagram showing a disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates example techniques for transmitting on-demand synchronization signal block (SSB) without always-on SSB.

FIG. 5B illustrates example techniques for transmitting on-demand SSB with always-on SSB.

FIG. 6 illustrates a timing diagram showing a UE receiving on-demand (OD) SSB.

FIG. 7 is a timing diagram illustrating example SSB transmissions for a plurality of UEs.

FIGS. 8A and 8B illustrate a timing offset T for a UE's signaling processing, in accordance with certain aspects of the present disclosure.

FIG. 9 illustrates an OD-SSB transmitted at a third candidate SSB bust after T, in accordance with certain aspects of the present disclosure.

FIG. 10 illustrates an OD-SSB being transmitted before a configured number (P) of slots or frames, in accordance with certain aspects of the present disclosure.

FIG. 11 depicts a method for wireless communications.

FIG. 12 depicts a method for wireless communications.

FIG. 13 depicts aspects of an example communications device.

FIG. 14 depicts aspects of an example communications device.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards apparatus and techniques for on-demand synchronization signal block (SSB) operations. SSBs are used to enable a user equipment (UE) to perform various tasks such as detecting and synchronizing with a cell. SSBs may be transmitted periodically. In some cases, SSBs may be transmitted on demand. For example, the network may selectively trigger SSB transmissions for specific purposes, such as for cell activation or measurement procedures. On-demand SSB transmissions allow for dynamic control over SSB timing and periodicity. In some aspects, on-demand SSB transmissions may be tailored to specific UE capabilities. For example, a UE may transmit, to a network entity, capability information indicating a parameter for determining a time period (e.g., a certain number of slots) associated with an SSB transmission. For example, the parameter may indicate support for the time period associated with preparing (or processing) to receive the SSB transmission. The network entity may then transmit, to the UE, an indication of the SSB transmission (e.g., on-demand SSB transmission) to be performed. The on-demand SSB transmission may be performed at a time instance after at least the time period (e.g., the certain number of slots) following the transmission of the indication by the network entity. The time period may be based on the capability of the UE. In some cases, the time period may be different depending on a process to be performed via the SSB transmission, such as a secondary cell activation procedure. In some cases, an upper limit may be placed on how late the SSB transmission may be transmitted, as described in more detail herein.

### Introduction to Wireless Communications Networks

The techniques and methods described herein may be used for various wireless communications networks. While aspects may be described herein using terminology commonly associated with 3G, 4G, 5G, and/or 6G wireless technologies, aspects of the present disclosure may likewise be applicable to other communications systems and standards not explicitly mentioned herein.

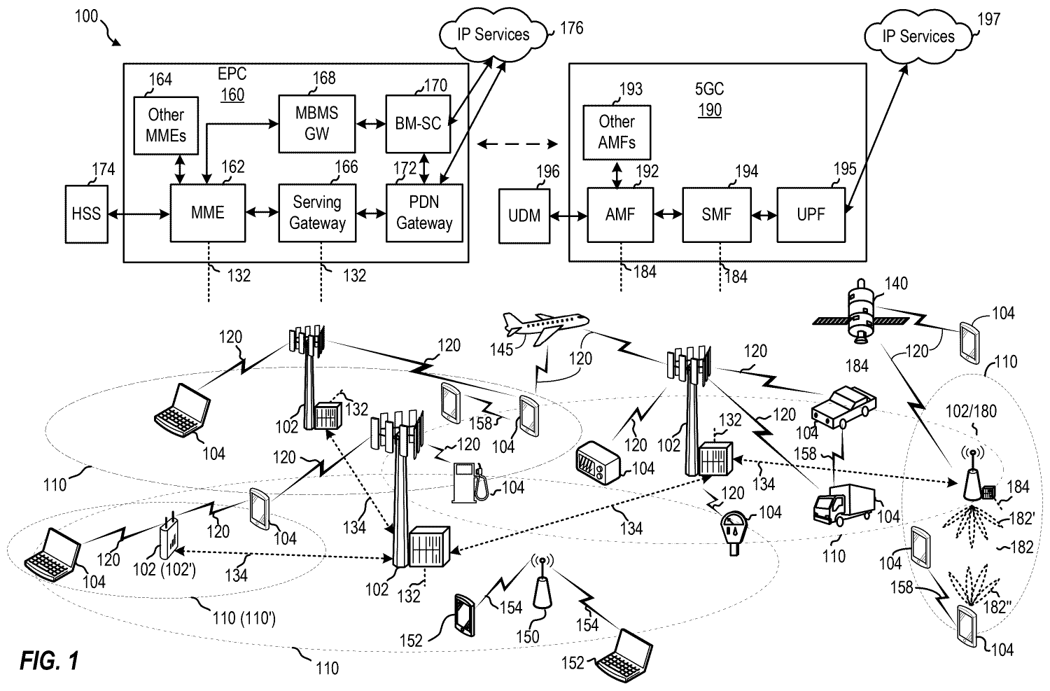

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

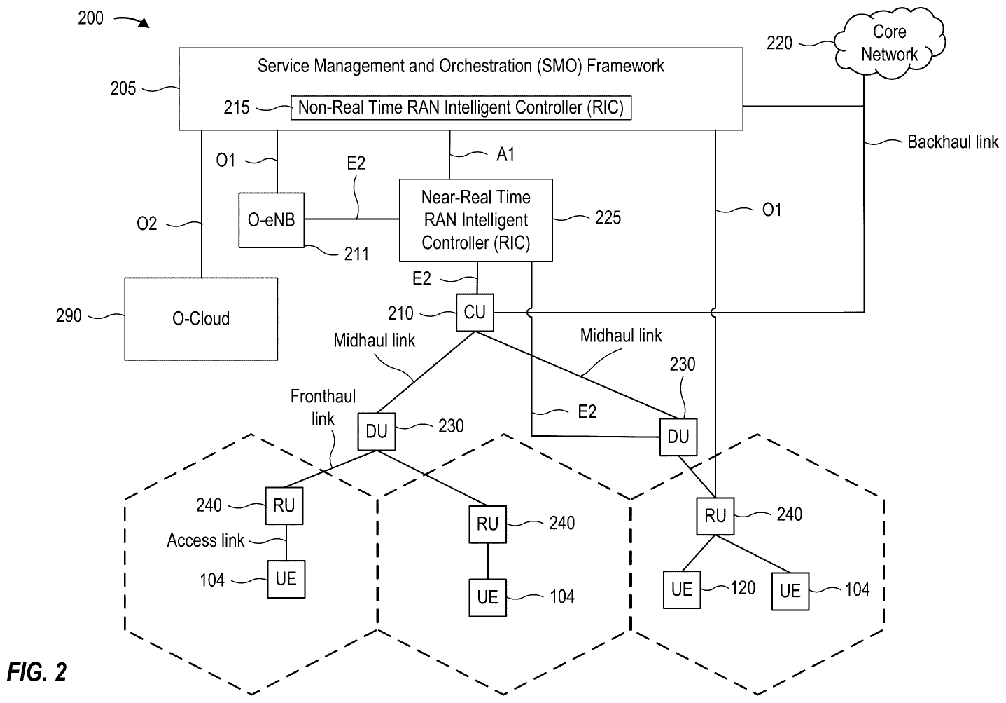

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G New Radio (NR) or Next Generation RAN (NG-RAN)) may interface with 5GC network 190 through second backhaul links 184. BSs 102 may communicate directly or indirectly (e.g., through the EPC 160 or 5GC network 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz.” Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting MBMS-related charging information.

5GC network 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC network 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC network 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example diagram 200 showing a disaggregated base station architecture. The disaggregated base station may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a VRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence/machine learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

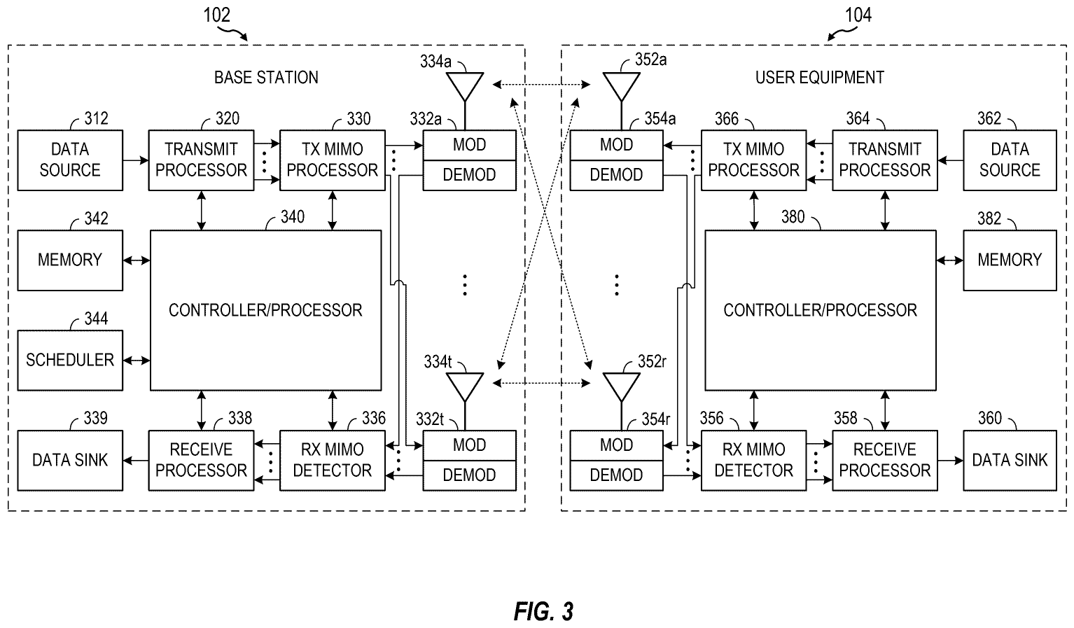

FIG. 3 depicts aspects of an example BS 102 and a UE 104.

Generally, BS 102 includes various processors (e.g., 320, 330, 338, and 340), antennas 334a-t (collectively “antennas 334”), transceivers 332a-t (collectively “transceivers 332”), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively “antennas 352”), transceivers 354a-r (collectively “transceivers 354”), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a transmit MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, transmit MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, receive (RX) MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, transmit MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

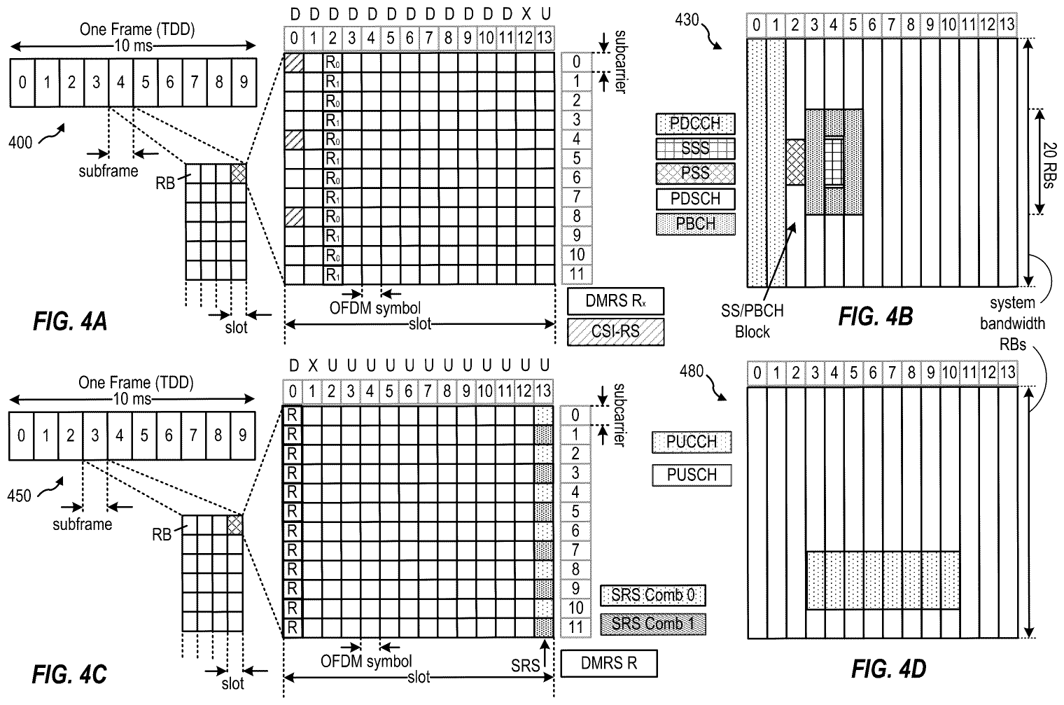

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledged/not acknowledged (ACK/NACK) feedback. The PUSCH carries data, and may additionally be used to carry a buffer status report (BSR), a power headroom report (PHR), and/or UCI.

### Techniques for On-Demand Synchronization Signal Block (SSB) Operations

Some implementations support on-demand synchronization signal block (SSB) operations for connected mode user equipments (UEs) configured with carrier aggregation (CA) as a technique to improve network energy savings. Some aspects provide procedures and signaling techniques to support on-demand SSB operations for UEs in connected mode configured with CA, which may be applied for intra-band and inter-band CA. Some aspects specify triggering techniques for on-demand SSB, which may be selected from a UE uplink wake-up signal using an existing signal/channel, cell on/off indication via backhaul, Scell activation/deactivation signaling, or a new signaling. On-demand SSB transmission may be used by a UE for e.g., SCell time/frequency synchronization, layer 1 (L1)/layer 3 (L3) measurements and SCell activation, and may be supported for frequency ranges (e.g., FR1 and FR2) in a non-shared spectrum. FR1, which may also be known as Sub-6 GHZ, encompasses frequencies from 410 MHz to 7.125 GHZ, while FR2, which may also be known as millimeter wave (mmWave), covers frequencies from 24.25 GHz to 52.6 GHz.

Multiple cases may exist of how always-on (e.g., periodic) SSB is transmitted in a cell that supports on-demand SSB operations. Regarding the UE assumption on SSB transmission on a cell supporting on-demand SSB operation, one operating case may involve no always-on SSB on the cell, and another operating case may involve always-on SSB being periodically transmitted on the cell.

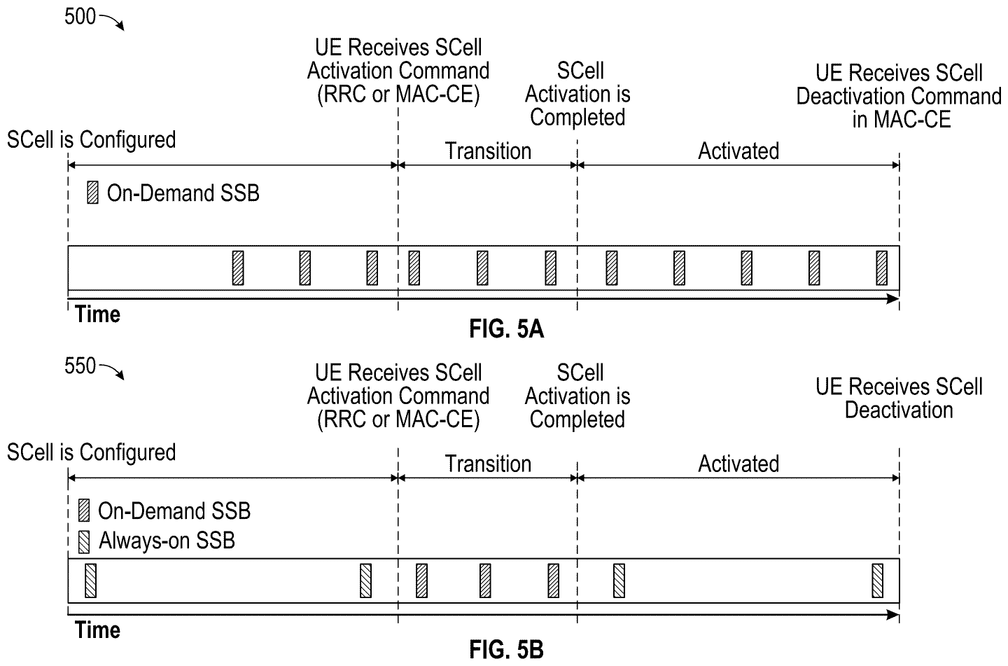

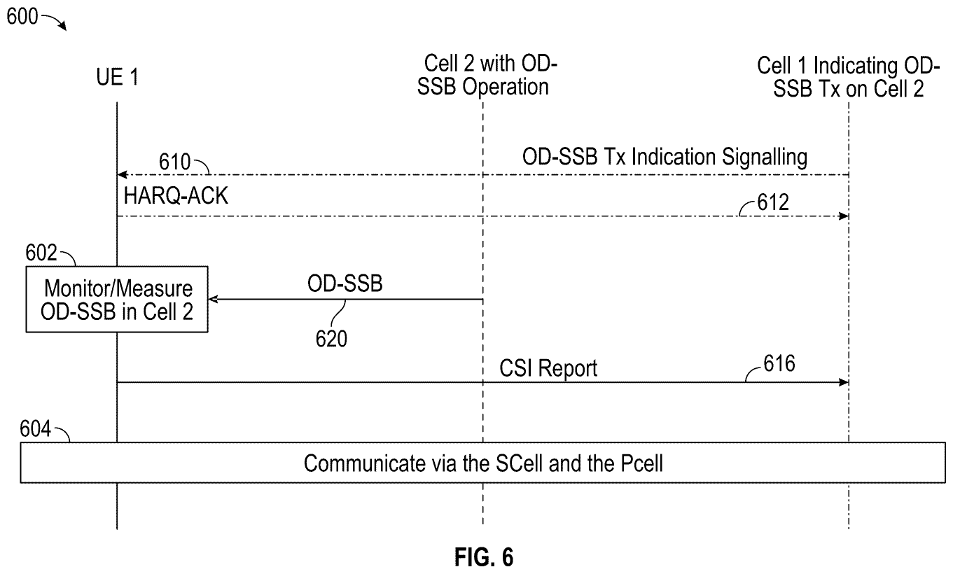

FIG. 5A illustrates example techniques for transmitting on-demand SSB 500 without always-on SSB, in accordance with certain aspects of the present disclosure. As shown, an SCell may be configured and a UE may receive an SCell activation command via a radio resource control (RRC) or media access control (MAC)-control element (CE) message. Upon receiving the activation command, the UE may transition (e.g., during a transmission phase labeled “Transition”) to activate the SCell. The transition may involve performing SSB measurements and sending a channel state information (CSI) report to the network upon completion. Thus, as shown, the network may indicate (e.g., activate) on-demand SSB transmissions that the UE may use to perform the SSB measurements for the CSI report or L1/L3 measurement. The UE may receive the signaling (RRC or MAC-CE) indicating the transmission of on-demand SSB before the UE receives the Scell activation command or when the Scell is deactivated. The on-demand SSB can be transmitted when the cell is deactivated, during the transition from Scell deactivated state to Scell activated state, or while in the Scell activated state. In other words, the transmissions of on-demand SSB may be ongoing even before the UE receives Scell activation command. The on-demand SSB transmissions may have a shorter periodicity cycle (e.g., as compared to always-on SSB transmissions) to reduce the SCell activation latency.

After the SCell is activated, the UE may receive an SCell deactivation command (e.g., as part of a MAC-CE message). In some cases, the network may transmit an indication to update the on-demand SSB configuration. For example, the network may send an indication to the UE with an SSB periodicity when the on-demand SSB is transmitted before the UE receives the Scell activation command. The network may then update the shorter periodicity for SSB transmission after the UE receives the Scell activation command, thereby reducing the latency associated with SCell activation.

FIG. 5B illustrates example techniques for transmitting on-demand SSB 550 with always-on SSB, in accordance with certain aspects of the present disclosure. As shown, always-on SSB transmission may be ongoing. In addition to the always-on SSB, the network may indicate on-demand SSB transmission upon transmitting the SCell activation command to the UE. While FIG. 5B shows the on-demand SSB transmission being transmitted after the SCell activation command, the on-demand SSB may be transmitted before the Scell activation command and/or after the Scell activation command. As shown, the on-demand SSB transmissions may facilitate SCell activation as described herein and can be deactivated after the SCell activation is complete.

When and/or how the network (e.g., base station (BS)) triggers on-demand SSB transmissions may be transparent to the UE. However, the UE may be informed when the network activates the on-demand SSB transmissions. The activation of the on-deman SSB transmission may occur before, together with, or after the reception of the Scell activation command and until the time the Scell is deactivated. The BS may indicate the on-demand SSB activation using RRC-based and/or MAC-CE-based signaling. RRC-based or MAC-CE-based signaling may be used to indicate on-demand SSB transmission on the cell. In some cases, downlink control information (DCI)-based signaling may be used to indicate on-demand SSB transmission on the cell. In some cases, the DCI signaling may or may not provide an indication of SCell activation/deactivation. The DCI may be UE-specific or a group-common DCI.

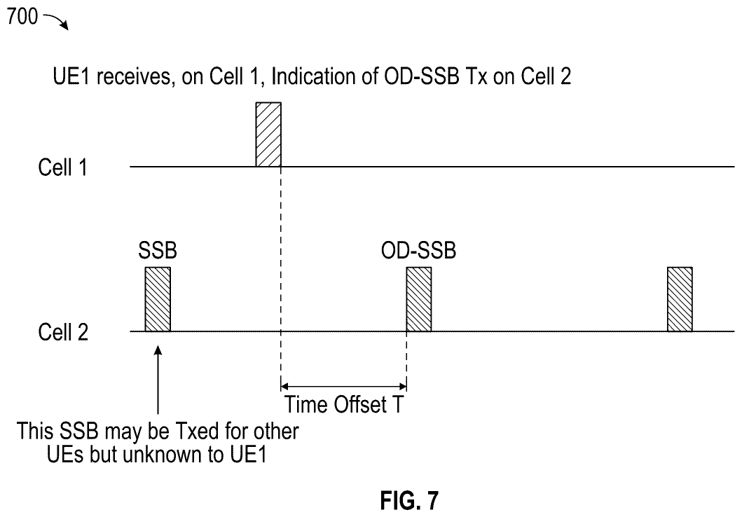

FIG. 6 illustrates a timing diagram 600 showing on-demand (OD) SSB activation, in accordance with certain aspect of the present disclosure. As shown, a UE (labeled “UE1”) may receive OD-SSB transmission indication signaling 610 from a BS on a first cell (e.g., referred to herein as “Cell 1”, which may be a PCell). The OD-SSB transmission 620 may occur on a second cell (e.g., referred to herein as “Cell 2”, which may be an SCell). UE1 may respond with a hybrid automatic request (HARQ)-acknowledgment (ACK) 612, indicating that the OD-SSB transmission indication signaling was successfully received. At block 602, UE1 may monitor for the OD-SSB transmission and perform one or more measurements for one or more SSBs received via the OD-SSB transmission on Cell 2. Based on the one or more measurements, UE1 may send a CSI report 616 to the BS (e.g., on the PCell). At block 604, UE1 may then communicate via Cell 2 and/or Cell 1 as shown.

One or more SSBs associated with the OD-SSB transmission may be transmitted on the second cell (e.g., for another connected mode UE) before UE1 receives the indication of OD-SSB transmission. However, from UE1's perspective, UE1 may be only aware of the OD-SSB transmission within a time period (e.g., time duration) after receiving the indication of OD-SSB transmission from the BS.

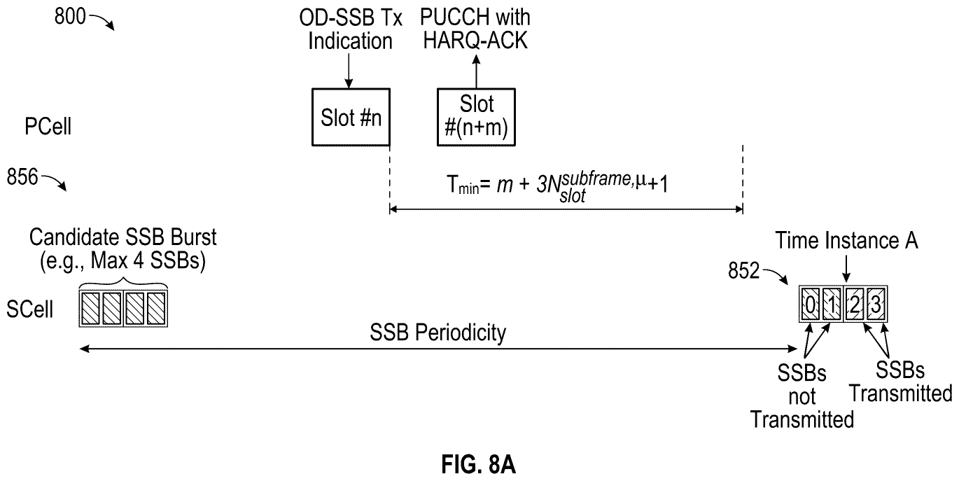

FIG. 7 is a timing diagram 700 illustrating example SSB transmissions for a plurality of UEs including UE1 and one or more other UEs. As shown, SSB transmissions may be performed on Cell 2 for one or more other UEs and UE1 may be unaware of the other SSB transmissions. UE1 may then receive, on Cell 1, the indication of the OD-SSB transmission, where the OD-SSB transmission is on Cell 2. After a specific time offset T, UE1 may begin monitoring for and receiving one or more SSBs associated with the OD-SSB transmission on Cell 2, as shown.

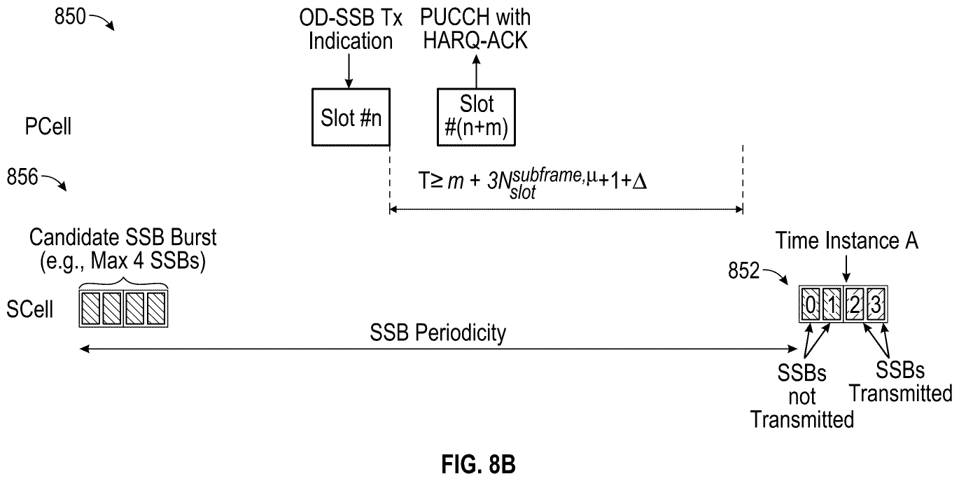

FIGS. 8A and 8B show timing diagrams 800, 850 illustrating a timing offset T for a UE's MAC-CE processing for SCell activation, in accordance with certain aspects of the present disclosure. In some aspects, for at least one SSB burst 852 indicated by on-demand SSB operation via MAC-CE, a UE may expect that the at least one on-demand SSB burst 852 is transmitted at a time instance labeled “Time instance A” in FIGS. 8A and 8B. Time instance A may be the beginning of a first slot containing an initial candidate SSB (e.g., SSB associated with index 0) or the first actually transmitted SSB (e.g. which may be the SSB with index 2 in the example shown in FIGS. 8A and 8B) of the on-demand SSB burst 852. A candidate SSB or SSB resource refers to a resource that can be selected for SSB transmission. The SSB burst 852 may begin at least T slots after the slot (e.g., labeled “Slot #n”, n being a positive integer), in which the UE receives signaling from the BS to indicate an on-demand SSB transmission. The SSB time domain positions of the on-demand SSB burst 852 may be configured by the BS. The value of T may not be less than the existing timeline for the UE's MAC-CE processing for SCell activation. In other words, T may not be less than a minimum time threshold (Tₘᵢₙ). As shown in timing diagram 800 of FIG. 8A, Tₘᵢₙ may be calculated in accordance with the following example equation:

$${T}_{min} = m + 3 {N}_{slot}^{subframe , μ} + 1$$

The slot labeled “Slot n+m” may be used for a physical uplink control channel (PUCCH) transmission with HARQ-ACK information (e.g., corresponding to the HARQ-ACK 612 described with respect to FIG. 6) when the UE receives MAC-CE signaling to indicate on-demand SSB transmission in slot n.

$${N}_{slot}^{subframe , μ}$$

may be equal to, for example, the number of slots within Ims. This may apply where the SCell performing the on-demand SSB transmission and the cell (e.g., Pcell) signaling the OD-SSB transmission indication have the same numerology (e.g., subcarrier spacing (SCS)). The determination of the minimum time threshold can also be based on other suitable equations. In some examples, the UE may indicate a parameter as capability information to the base station. The parameter may be used to directly or indirectly indicate one or more of the values in the equation for determining the minimum time threshold.

As shown, a candidate SSB burst 856 (e.g., including a maximum of four SSBs) may be transmitted on the SCell, after which a BS may transmit, to a UE in slot #n, the OD-SSB transmission indication. In slot #(n+m), the UE may respond to the BS with a PUCCH containing a HARQ ACK, as described herein, where n and m are positive integers.

The timing offset for the UE to process the MAC-CE before UE1 can receive the OD-SSB (e.g., burst 852) begins from slot #n as shown. As shown, SSB bursts may be transmitted with a certain SSB periodicity. In the example shown in FIG. 8A, the SSB burst may include four SSBs with indices 0-3. The OD-SSB may be transmitted for UE1 at time instance A. For example, at least after time T, time instance A may be at the beginning of a first slot containing the first actually transmitted SSB index, which is shown in FIG. 8A, may be the SSB with index 2 as described. In some cases, time instance A may be at the beginning of a first slot containing a candidate SSB index 0. In that case, time instance A would be at the beginning of the first slot including the SSB with index 0. In some cases, the network may transmit (e.g., as preconfigured by standards) the on-demand SSB in the first candidate SSB burst after T slots. However, in some cases, the standards may not indicate that the SSB is to be transmitted in the first candidate SSB burst after T slots. In this case, an upper limit P regarding when the on-demand SSB may be transmitted may be introduced, as described in more detail herein.

In some aspects of the present disclosure, some timing margin Δ (e.g., Δ_{MAC-CE}) may be implemented as shown in timing diagram 850 of FIG. 8B. For example, the value of T may be:

$$T >= T\_min + Δ = m + 3 {N}_{slot}^{subframe , μ} + 1 + Δ$$

The timing margin Δ may be used to adjust the value T in consideration of different preparation times for different use cases. That is, the timing margin may differ for various on-demand SSB use cases. For example, when using on-demand SSB for an Scell activation procedure, the timing margin may be larger than the margin used when performing on-demand SSB for automatic gain control (AGC)/measurement.

The margin values for different use cases (e.g., such as Scell activation vs. other cases) can be pre-defined in the standard. To accommodate various UE implementations, the UE may indicate a parameter as capability information to the base station. The parameter may be used to directly or indirectly indicate a supported value for Δ. For example, a list of values may be provided in a feature group (e.g., signaled per UE, per band combination, or per feature set) and the UE may report one of the values from the list. That is, in some aspects, a UE may indicate the supported value for Δ as part of UE capability. The value of Δ may be different for different usages of on-demand SSB (e.g., for Scell activation procedure vs. for other usages). For instance, depending on the use case of the SSB and the UE implementation, the UE may use more time to prepare for receiving the OD-SSB. In some cases, the value of Δ may be different for SSB transmission cases, such as the case described with respect to FIG. 5A without always-on SSB or the case described with respect to FIG. 5B with always-on SSB. Depending on the SSB transmission case, the UE may use more time to prepare for receiving the OD-SSB. The UE may use less time to prepare without always-on SSB. For instance, if the always-on SSB is transmitted, the UE may identify the resource for receiving the OD-SSB with reference to the timing derived from the always-on SSB, allowing the UE to receive the OD-SSB with reduced latency.

As described, time instance A may be at the beginning of the first slot containing SSB index 0 or the first actually transmitted SSB of the on-demand SSB burst which is at least T slots after the slot where UE receives a signaling from the BS to indicate on-demand SSB transmission. The term “at least” may allow the BS to transmit the OD-SSB anytime after the time T (e.g., or T slots after the signaling from the BS to indicate on-demand SSB transmission). The BS may actually transmit SSBs starting from any candidate SSB burst after T slots. A BS may transmit SSB right after T slots, such as using the first candidate SSB burst after the T slots. Transmitting the SSB using the first candidate SSB burst may benefit the UE, especially when on-demand SSB is used for Scell activation in order to provide low Scell activation latency. However, there may be an implementation where the BS only transmits SSB at the Kth candidate SSB burst after T slots, K being a positive integer.

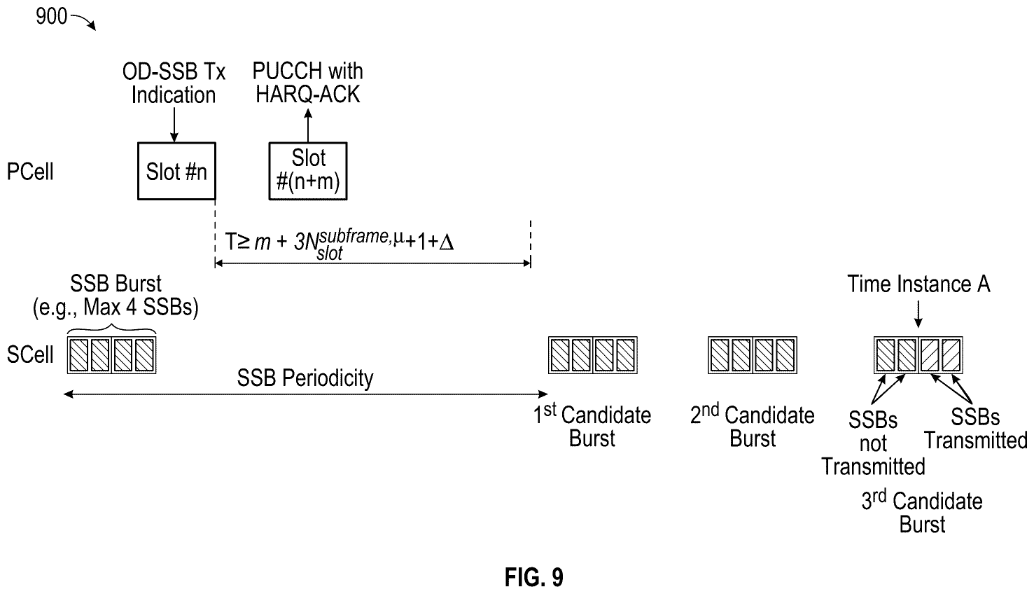

FIG. 9 illustrates a timing diagram 900 showing an OD-SSB transmitted at a third candidate SSB burst after T slots, in accordance with certain aspects of the present disclosure. There may be multiple candidate SSB bursts, such as the candidate SSB bursts labeled “1^{st} Candidate Burst”, “2^{nd} Candidate Burst”, and “3^{rd} Candidate Burst” in the timing diagram 900. As shown, the OD-SSB may be transmitted in the third candidate SSB burst after the T slots, which may cause some issues. For example, for an Scell activation procedure, this may lead to a long activation latency, defeating the purpose of on-demand SSB. To search for an on-demand SSB on the Scell, a UE may attempt to perform a single short SSB detection (e.g., since the SCell channel quality may be expected to be reasonably high). However, the UE may not be able to detect the on-demand SSB since there is no SSB transmission within the UE's configured search window. In other words, the configured search window of the UE may only include the first candidate SSB burst. As another example issue, to perform an on-demand SSB-based measurement, the UE may check in each candidate SSB burst to identify whether the SSB is transmitted until the UE detects the transmitted SSB (e.g., or until the UE finds time instance A, assuming this time instance depends on the actually transmitted SSB), causing inefficiencies if the SSB is not transmitted in the first few SSB bursts after time T as the UE has to keep monitoring each SSB burst.

To have proper operations and UE implementation, some aspects implement an upper limit on the time that the BS transmits the OD-SSB. For instance, for SSB burst(s) indicated by on-demand SSB SCell operation via MAC CE, the UE may expect that the on-demand SSB burst(s) is transmitted at time instance A, where time instance A is at the beginning of the slot containing [candidate SSB index 0 or the first actually transmitted SSB index] of on-demand SSB burst which is at least T slots after the slot where UE receives signaling from BS to indicate on-demand SSB transmission and within (e.g., before) P [slots or frames] after the T slots.

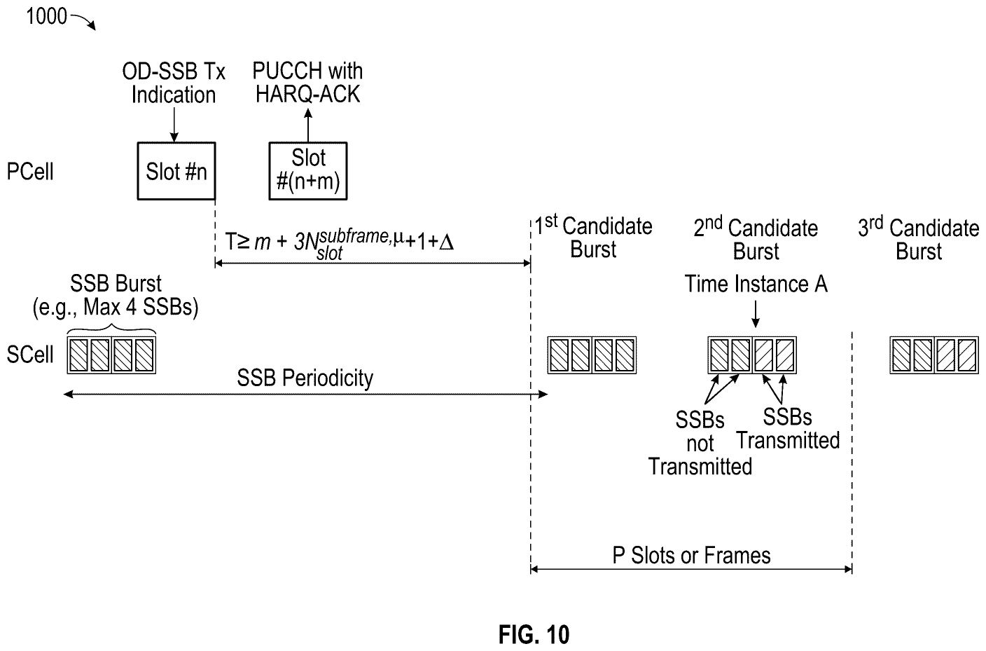

FIG. 10 illustrates a timing diagram 1000 showing an OD-SSB being transmitted before a configured number (P) of slots or frames, in accordance with certain aspects of the present disclosure. As shown, the OD-SSB may be transmitted in the second candidate SSB burst, which is within (e.g., before the end of) P slots or frames after the T slots. For SSB burst(s) indicated by on-demand SSB SCell operation via MAC CE, the UE may expect that on-demand SSB burst(s) is transmitted from time instance A. As described, time instance A may be at the beginning of the slot containing candidate SSB index 0 or the first actually transmitted SSB index of an on-demand SSB burst which is at least T slots after the slot where UE receives signaling from the BS to indicate on-demand SSB transmission and before P slots or frames after the T slots or not later than P slots or frames after the T slots.

In some cases, the on-demand SSB transmission may be adapted at least based on the periodicity of the on-demand SSB (e.g., time domain adaptation). For a cell supporting on-demand SSB SCell operation, at least for one or more parameters such as the periodicity of the on-demand SSB, multiple candidate values may be network configured by RRC and the applicable value may be indicated by the network to the UE by MAC-CE for on-demand SSB transmission indication for the cell.

In some aspects, the value of P may depend on the configured/fixed or indicated (e.g., if MAC-CE is also used for OD-SSB periodicity adaptation) SSB periodicity of the Scell (e.g., since a longer period provides more time for the UE to prepare for receiving the SSB). In some cases, additionally or alternatively, the value of P may depend on the periodicity of a configured SSB measurement timing configuration (SMTC) for the Scell. For example, a UE may perform measurements during certain measurement windows with a certain periodicity, where the value P may be based on the periodicity of the measurement windows.

Without the upper limit (e.g., P slots) being configured, the UE may be unable to detect on-demand SSB within a given time duration. In some cases, the UE may send an indication back to the BS on the Pcell that the on-demand SSB on the Scell associated with the on-demand SSB transmission is not detected. In some cases, the indication may be applied to an Scell activation procedure only. For measurement, the UE may not indicate to the BS whether the on-demand SSB was received or not since, if not received, the UE would not take the measurement from the Scell into account. Thus, the UE may indicate that the on-demand SSB is not detected in the Scell associated with the on-demand SSB transmission indication. The indication may be sent to the BS on the Pcell. This indication may be used when using the on-demand SSB is for an Scell activation procedure.

### Example Operations

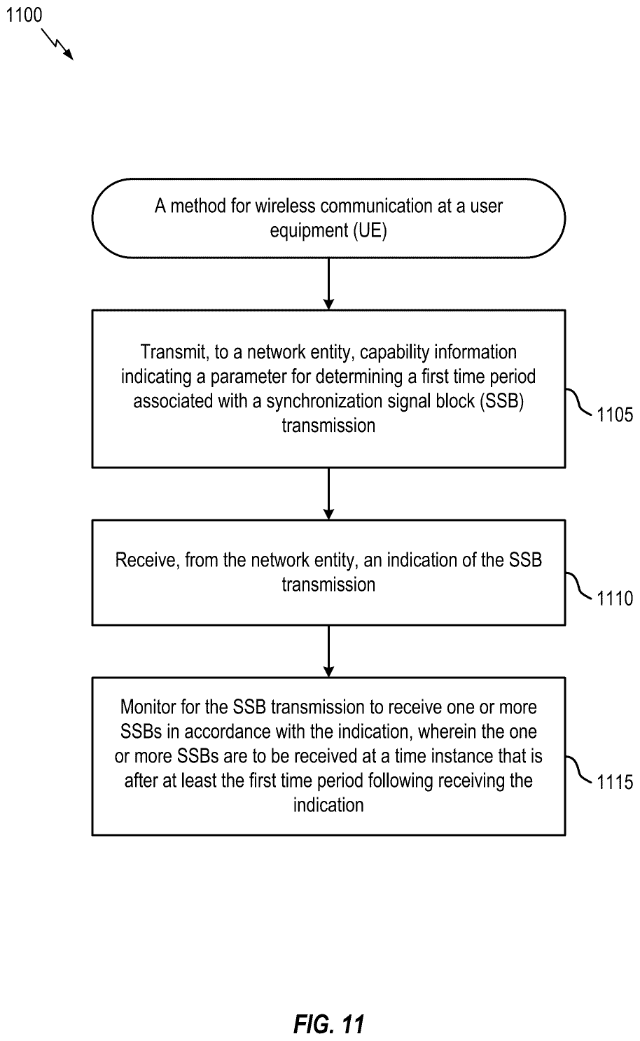

FIG. 11 shows an example of a method 1100 of wireless communications at a user equipment (UE), such as a UE 104 of FIGS. 1, 2, and 3, or UE1 in FIG. 6 or 7.

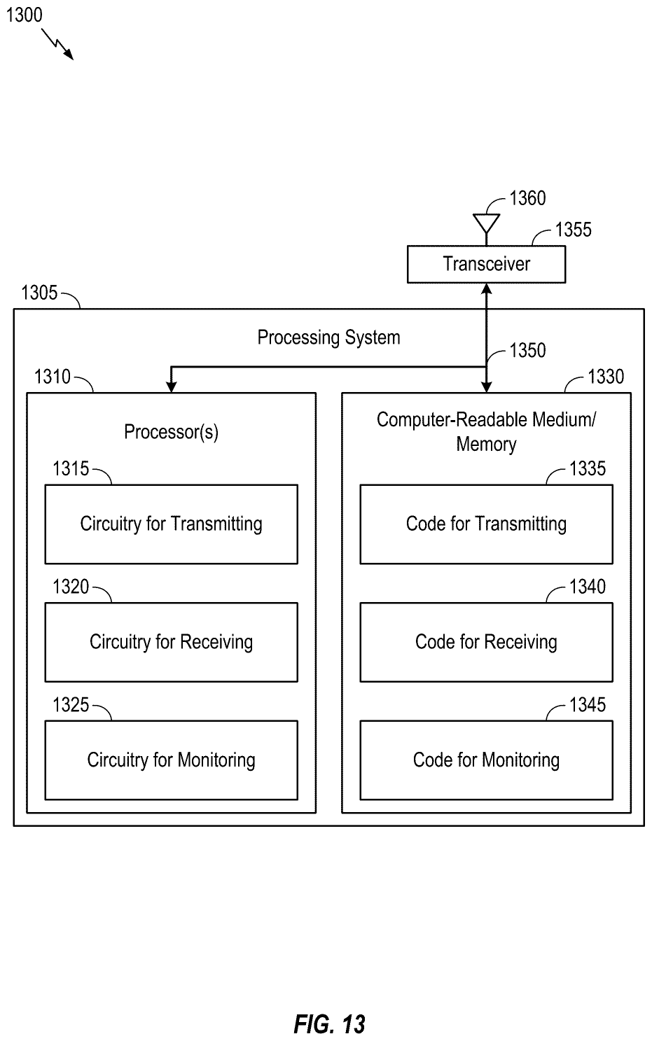

Method 1100 begins at step 1105 with transmitting, to a network entity, capability information indicating a parameter for determining a first time period associated with a synchronization signal block (SSB) transmission. In some cases, the operations of this step refer to, or may be performed by, circuitry for transmitting and/or code for transmitting as described with reference to FIG. 13. The parameter may indicate support for the first time period associated preparation to receive the SSB transmission.

Method 1100 then proceeds to step 1110 with receiving, from the network entity, an indication of the SSB transmission. In some cases, the operations of this step refer to, or may be performed by, circuitry for receiving and/or code for receiving as described with reference to FIG. 13.

Method 1100 then proceeds to step 1115 with monitoring for the SSB transmission to receive one or more SSBs in accordance with the indication, wherein the one or more SSBs are to be received at a time instance that is after at least the first time period following receiving the indication. In some cases, the operations of this step refer to, or may be performed by, circuitry for monitoring and/or code for monitoring as described with reference to FIG. 13.

In some aspects, the one or more SSBs are to be received at least the first time period after a slot in which the indication is received.

In some aspects, the first time period corresponds to a number of slots, subframes, or frames.

In some aspects, the parameter for determining the the first time period is based on (e.g., is determined by the UE based on) a procedure to be performed via the one or more SSBs.

In some aspects, the procedure comprises a secondary cell activation procedure.

In some aspects, the parameter for determining the first time period is based on (e.g., is determined by the UE based on) whether there are ongoing periodic SSB transmissions when the indication is received.

In some aspects, the one or more SSBs are to be received in a slot containing a candidate SSB resource that is first in time in an SSB burst, the SSB burst occurring at least the first time period after receiving the indication. In some cases, the candidate SSB resource may be an SSB resource that is available first in time the first time period after receiving the indication.

In some aspects, the one or more SSBs are received in a slot used for SSB transmission first in time in an SSB burst, the SSB burst occurring at least the first time period after receiving the indication.

In some aspects, the one or more SSBs are received within a second time period following the first time period.

In some aspects, the second time period corresponding to a number of slots, subframes, or frames.

In some aspects, the second time period is based on (e.g., is determined by the UE based on) a periodicity associated with SSB transmissions including the one or more SSBs.

In some aspects, the second time period is based on (e.g., is determined by the UE based on) a periodicity associated with SSB measurements for a secondary cell.

In some aspects, the method 1100 further includes transmitting, after the monitoring, a network feedback indication indicating that the one or more SSBs were not received. In some cases, the operations of this step refer to, or may be performed by, circuitry for transmitting and/or code for transmitting as described with reference to FIG. 13.

In some aspects, the network feedback indication is transmitted on a primary cell.

In some aspects, the network feedback indication is transmitted when a secondary cell activation procedure is to be performed via the one or more SSBs.

In some aspects, the indication of the SSB transmission including the one or more SSBs is received on a first cell, and the one or more SSBs are received on a second cell different than the first cell.

In some aspects, the first time period is determined based on an on-demand SSB use case.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

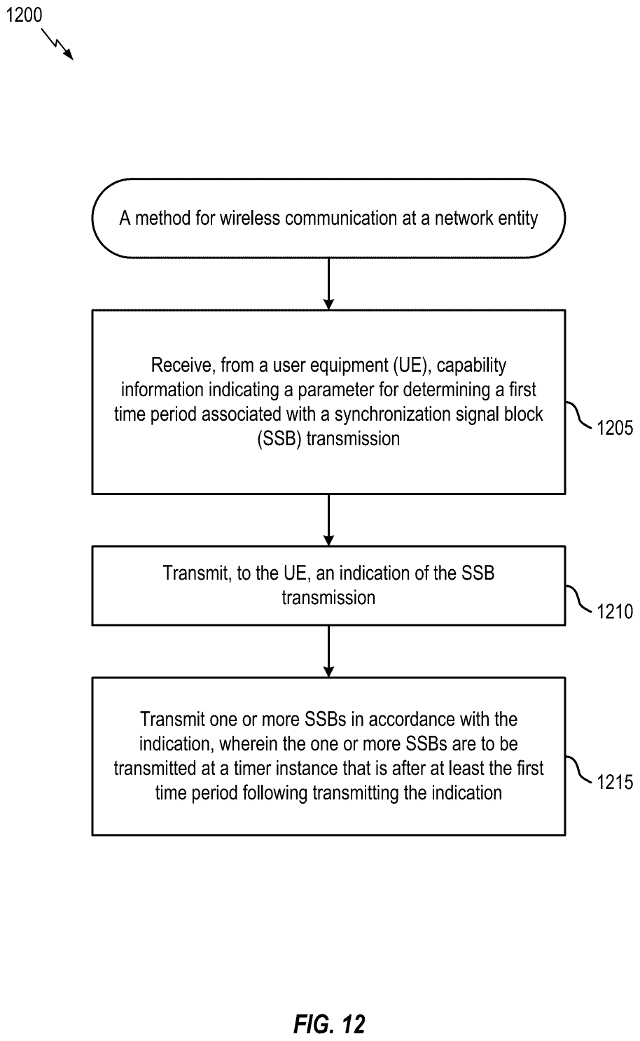

FIG. 12 shows an example of a method 1200 of wireless communication at a network entity, such as a BS 102 of FIGS. 1 and 3, or a disaggregated base station as discussed with respect to FIG. 2.

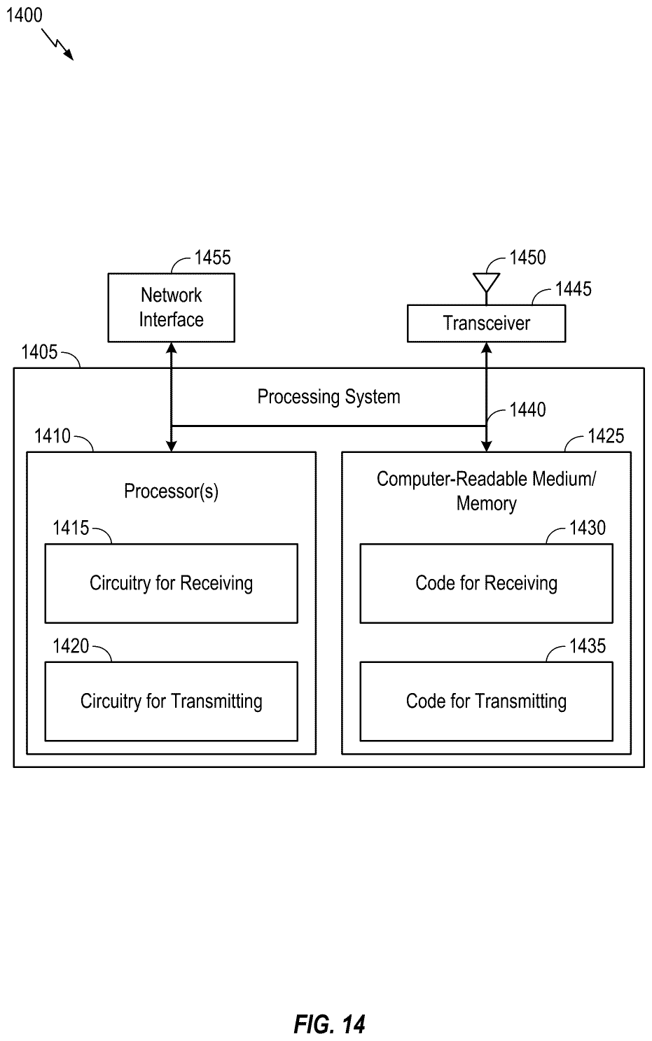

Method 1200 begins at step 1205 with receiving, from a user equipment (UE), capability information indicating a parameter for determining a first time period associated with a synchronization signal block (SSB) transmission. In some cases, the operations of this step refer to, or may be performed by, circuitry for receiving and/or code for receiving as described with reference to FIG. 14. The parameter may indicate support for the first time period associated preparation to receive the SSB transmission.

Method 1200 then proceeds to step 1210 with transmitting, to the UE, an indication of the SSB transmission. In some cases, the operations of this step refer to, or may be performed by, circuitry for transmitting and/or code for transmitting as described with reference to FIG. 14.

Method 1200 then proceeds to step 1215 with transmitting one or more SSBs in accordance with the indication, wherein the one or more SSBs are to be transmitted at a time instance that is at least the first time period following transmitting the indication. In some cases, the operations of this step refer to, or may be performed by, circuitry for transmitting and/or code for transmitting as described with reference to FIG. 14.

In some aspects, the first time period is after a slot, subframe, or frame in which the indication is received.

In some aspects, the first time period corresponds to a number of slots, subframes, or frames.

In some aspects, the parameter for determining the first time period is based on a procedure to be performed via the one or more SSBs.

In some aspects, the procedure comprises a secondary cell activation procedure.

In some aspects, the parameter for determining the first time period is based on whether there are ongoing periodic SSB transmissions when the indication is received.

In some aspects, the one or more SSBs are transmitted in a slot containing a candidate SSB resource that is first in time in an SSB burst, the SSB burst occurring at least the first time period after receiving the indication.

In some aspects, the one or more SSBs are transmitted in a slot used for SSB transmission first in time in an SSB burst, the SSB burst occurring at least the first time period after receiving the indication.

In some aspects, the one or more SSBs are transmitted within a second time period after the first time period.

In some aspects, the second time period corresponds to a number of slots, subframes, or frames.

In some aspects, the second time period is based on a periodicity associated with SSB transmissions including the one or more SSBs.

In some aspects, the second time period is based on a periodicity associated with SSB measurements for a secondary cell.

In some aspects, the method 1200 further includes receiving, from the UE, a network feedback indication that the one or more SSBs were not received by the UE. In some cases, the operations of this step refer to, or may be performed by, circuitry for receiving and/or code for receiving as described with reference to FIG. 14.

In some aspects, the network feedback indication is received on a primary cell.

In some aspects, the network feedback indication is received when a secondary cell activation procedure is to be performed via the one or more SSBs.

In some aspects, the indication of the SSB transmission including the one or more SSBs is received on a first cell, and the one or more SSBs are received on a second cell different than the first cell.

In some aspects, the first time period is determined based on an on-demand SSB use case.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Communications Device(s)

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to the transceiver 1355 (e.g., a transmitter and/or a receiver). The transceiver 1355 is configured to transmit and receive signals for the communications device 1300 via the antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, cause the one or more processors 1310 to perform the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1330 stores code (e.g., executable instructions), such as code for transmitting 1335, code for receiving 1340, and code for monitoring 1345. Processing of the code for transmitting 1335, code for receiving 1340, and code for monitoring 1345 may cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry such as circuitry for transmitting 1315, circuitry for receiving 1320, and circuitry for monitoring 1325. Processing with circuitry for transmitting 1315, circuitry for receiving 1320, and circuitry for monitoring 1325 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1355 and the antenna 1360 of the communications device 1300 in FIG. 13. Means for receiving or obtaining may include transceivers 354 and/or antenna(s) 352 of the UE 104 illustrated in FIG. 3 and/or the transceiver 1355 and the antenna 1360 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1445 (e.g., a transmitter and/or a receiver) and/or a network interface 1455. The transceiver 1445 is configured to transmit and receive signals for the communications device 1400 via the antenna 1450, such as the various signals as described herein. The network interface 1455 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, or any aspect related to it. Note that reference to a processor of communications device 1400 performing a function may include one or more processors 1410 of communications device 1400 performing that function.

In the depicted example, the computer-readable medium/memory 1425 stores code (e.g., executable instructions), such as code for receiving 1430 and code for transmitting 1435. Processing of the code for receiving 1430 and code for transmitting 1435 may cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry such as circuitry for receiving 1415 and circuitry for transmitting 1420. Processing with circuitry for receiving 1415 and circuitry for transmitting 1420 may cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1445 and the antenna 1450 of the communications device 1400 in FIG. 14. Means for receiving or obtaining may include transceivers 332 and/or antenna(s) 334 of the BS 102 illustrated in FIG. 3 and/or the transceiver 1445 and the antenna 1450 of the communications device 1400 in FIG. 14.

### Example Aspects

Implementation examples are described in the following numbered clauses:

Aspect 1: An apparatus for wireless communications at a user equipment (UE), comprising: at least one memory for storing computer-executable instructions; and one or more processors operatively coupled to the at least one memory and configured to execute the computer-executable instructions to cause the apparatus to: transmit, to a network entity, capability information indicating a parameter for determining a first time period associated with a synchronization signal block (SSB) transmission; receive, from the network entity, an indication of the SSB transmission; and monitor for the SSB transmission to receive one or more SSBs in accordance with the indication, wherein the one or more SSBs are to be received at a time instance that is after at least the first time period following receiving the indication.

Aspect 2: The apparatus of Aspect 1, wherein the parameter indicates support for the first time period associated with preparation to receive the SSB transmission.

Aspect 3: The apparatus of Aspect 1 or 2, wherein the first time period starts after a slot, a subframe, or a frame in which the indication is received.

Aspect 4: The apparatus according to any of Aspects 1-3, wherein the first time period corresponds to a number of slots, subframes or frames.

Aspect 5: The apparatus according to any of Aspects 1-4, wherein the parameter for determining the first time period is based on a procedure to be performed via the one or more SSBs.

Aspect 6: The apparatus of Aspect 5, wherein the procedure comprises a secondary cell activation procedure.

Aspect 7: The apparatus according to any of Aspects 1-6, wherein the parameter for determining the first time period is based on whether there are ongoing periodic SSB transmissions when the indication is received.

Aspect 8: The apparatus according to any of Aspects 1-7, wherein the one or more processors are configured to cause the apparatus to receive the one or more SSBs in a slot containing a candidate SSB resource that is first in time in an SSB burst, the SSB burst occurring at least the first time period after receiving the indication.

Aspect 9: The apparatus according to any of Aspects 1-8, wherein the one or more processors are configured to cause the apparatus to receive the one or more SSBs in a slot used for SSB transmission first in time in an SSB burst, the SSB burst occurring at least the first time period after receiving the indication.

Aspect 10: The apparatus according to any of Aspects 1-9, wherein the one or more processors are configured to cause the apparatus to receive the one or more SSBs within a second time period following the first time period.

Aspect 11: The apparatus of Aspect 10, wherein the second time period corresponds to a number of slots, subframes, or frames.

Aspect 12: The apparatus of Aspect 10 or 11, wherein the second time period is based on a periodicity associated with SSB transmissions including the one or more SSBs.

Aspect 13: The apparatus according to any of Aspects 10-12, wherein the second time period is based on a periodicity associated with SSB measurements for a secondary cell.

Aspect 14: The apparatus according to any of Aspects 1-13, wherein the one or more processors are further configured to cause the apparatus to transmit, after the monitoring, a network feedback indication indicating that the one or more SSBs were not received.

Aspect 15: The apparatus of Aspect 14, wherein the one or more processors are configured to cause the apparatus to transmit the network feedback indication on a primary cell.

Aspect 16: The apparatus of Aspect 14 or 15, wherein the one or more processors are configured to cause the apparatus to transmit the network feedback indication when a secondary cell activation procedure is to be performed via the one or more SSBs.

Aspect 17: An apparatus for wireless communications at a network entity, comprising: at least one memory for storing computer-executable instructions; and one or more processors operatively coupled to the at least one memory and configured to execute the computer-executable instructions to cause the apparatus to: receive, from a user equipment (UE), capability information indicating a parameter for determining a first time period associated with a synchronization signal block (SSB) transmission; transmit, to the UE, an indication of the SSB transmission; and transmit one or more SSBs in accordance with the indication, wherein the one or more SSBs are to be transmitted at a time instance that is after at least the first time period following transmitting the indication.

Aspect 18: The apparatus of Aspect 17, wherein the parameter indicates support for the first time period associated with preparation to receive the SSB transmission.

Aspect 19: The apparatus of Aspect 17 or 18, wherein the first time period starts after a slot, a subframe, or frame in which the indication is received.

Aspect 20: The apparatus according to any of Aspects 17-19, wherein the first time period corresponds to a number of slots, subframes, or frames.

Aspect 21: The apparatus according to any of Aspects 17-20, wherein the parameter for determining the first time period is based on a procedure to be performed via the one or more SSBs.

Aspect 22: The apparatus of Aspect 21, wherein the procedure comprises a secondary cell activation procedure.

Aspect 23: The apparatus according to any of Aspects 17-22, wherein the parameter for determining the first time period is based on whether there are ongoing periodic SSB transmissions when the indication is received.

Aspect 24: The apparatus according to any of Aspects 17-23, wherein the one or more processors are configured to cause the apparatus to transmit the one or more SSBs in a slot containing a candidate SSB resource that is first in time in an SSB burst, the SSB burst occurring at least the first time period after receiving the indication.

Aspect 25: The apparatus according to any of Aspects 17-24, wherein the one or more processors are configured to cause the apparatus to transmit the one or more SSBs in a slot used for SSB transmission first in time in an SSB burst, the SSB burst occurring at least the first time period after receiving the indication.

Aspect 26: The apparatus according to any of Aspects 17-25, wherein the one or more processors are configured to cause the apparatus to transmit the one or more SSBs within a second time period following the first time period.

Aspect 27: The apparatus of Aspect 26, wherein the second time period corresponds to a number of slots, subframes, or frames.

Aspect 28: The apparatus of Aspect 26 or 27, wherein the second time period is based on a periodicity associated with SSB transmissions including the one or more SSBs.

Aspect 29: The apparatus according to any of Aspects 26-28, wherein the second time period is based on a periodicity associated with SSB measurements for a secondary cell.

Aspect 30: The apparatus according to any of Aspects 17-29, wherein the one or more processors are further configured to cause the apparatus to receive, from the UE, a network feedback indication indicating that the one or more SSBs were not received by the UE.

Aspect 31: A method for wireless communications at a user equipment (UE), comprising: transmitting, to a network entity, capability information indicating a parameter for determining a first time period associated with a synchronization signal block (SSB) transmission; receiving, from the network entity, an indication of the SSB transmission; and monitoring for the SSB transmission to receive one or more SSBs in accordance with the indication, wherein the one or more SSBs are to be received at a time instance that is after at least the first time period following receiving the indication.

Aspect 32: A method for wireless communications at a network entity, comprising: receiving, from a user equipment (UE), capability information indicating a parameter for determining a first time period associated with a synchronization signal block (SSB) transmission; transmitting, to the UE, an indication of the SSB transmission; and transmitting one or more SSBs in accordance with the indication, wherein the one or more SSBs are to be transmitted at a time instance that is after at least the first time period following transmitting the indication.

Aspect 31: An apparatus, comprising: at least one memory comprising executable instructions; and at least one processor configured to execute the executable instructions and cause the apparatus to perform a method in accordance with any combination of Aspects 1-32.

Aspect 32: An apparatus, comprising means for performing a method in accordance with any combination of Aspects 1-32.

Aspect 33: A non-transitory computer-readable medium comprising executable instructions that, when executed by at least one processor of an apparatus, cause the apparatus to perform a method in accordance with any combination of Aspects 1-32.

Aspect 34: A computer program product embodied on a computer-readable storage medium comprising code for performing a method in accordance with any combination of Aspects 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications at a user equipment (UE), comprising:
at least one memory for storing computer-executable instructions; and
one or more processors operatively coupled to the at least one memory and configured to execute the computer-executable instructions to cause the apparatus to:
transmit, to a network entity, capability information indicating a parameter for determining a first time period associated with a synchronization signal block (SSB) transmission;
receive, from the network entity, an indication of the SSB transmission; and
monitor for the SSB transmission to receive one or more SSBs in accordance with the indication, wherein the one or more SSBs are to be received at a time instance that is after at least the first time period following receiving the indication.

2. The apparatus of claim 1, wherein the parameter indicates support for the first time period associated preparation to receive the SSB transmission.

3. The apparatus of claim 1, wherein the first time period starts after a slot, a subframe, or a frame in which the indication is received.

4. The apparatus of claim 1, wherein the first time period corresponds to a number of slots, subframes or frames.

5. The apparatus of claim 1, wherein the parameter for determining the first time period is based on a procedure to be performed via the one or more SSBs.

6. The apparatus of claim 5, wherein the procedure comprises a secondary cell activation procedure.

7. The apparatus of claim 1, wherein the parameter for determining the first time period is based on whether there are ongoing periodic SSB transmissions when the indication is received.

8. The apparatus of claim 1, wherein the one or more processors are configured to cause the apparatus to receive the one or more SSBs in a slot containing a candidate SSB resource that is first in time in an SSB burst, the SSB burst occurring at least the first time period after receiving the indication.

9. The apparatus of claim 1, wherein the one or more processors are configured to cause the apparatus to receive the one or more SSBs in a slot used for SSB transmission first in time in an SSB burst, the SSB burst occurring at least the first time period after receiving the indication.

10. The apparatus of claim 1, wherein the one or more processors are configured to cause the apparatus to receive the one or more SSBs within to a second time period following the first time period.

11. The apparatus of claim 10, wherein the second time period corresponds to a number of slots, subframes, or frames.

12. The apparatus of claim 10, wherein the second time period is based on a periodicity associated with SSB transmissions including the one or more SSBs.

13. The apparatus of claim 10, wherein the second time period is based on a periodicity associated with SSB measurements for a secondary cell.

14. The apparatus of claim 1, wherein the one or more processors are further configured to cause the apparatus to transmit, after the monitoring, a network feedback indication indicating that the one or more SSBs were not received.

15. The apparatus of claim 14, wherein the one or more processors are configured to cause the apparatus to transmit the network feedback indication on a primary cell.

16. The apparatus of claim 14, wherein the one or more processors are configured to cause the apparatus to transmit the network feedback indication when a secondary cell activation procedure is to be performed via the one or more SSBs.

17. An apparatus for wireless communications at a network entity, comprising:
at least one memory for storing computer-executable instructions; and
one or more processors operatively coupled to the at least one memory and configured to execute the computer-executable instructions to cause the apparatus to:
receive, from a user equipment (UE), capability information indicating a parameter for determining a first time period associated with a synchronization signal block (SSB) transmission;
transmit, to the UE, an indication of the SSB transmission; and
transmit one or more SSBs in accordance with the indication, wherein the one or more SSBs are to be transmitted at a time instance that is after at least the first time period following transmitting the indication.

18. The apparatus of claim 17, wherein the parameter indicates support for the first time period associated preparation to receive the SSB transmission.

19. The apparatus of claim 17, wherein the first time period starts after a slot, a subframe, or frame in which the indication is received.

20. The apparatus of claim 17, wherein the first time period corresponds to a number of slots, subframes, or frames.

21. The apparatus of claim 17, wherein the parameter for determining the first time period is based on a procedure to be performed via the one or more SSBs.

22. The apparatus of claim 21, wherein the procedure comprises a secondary cell activation procedure.

23. The apparatus of claim 17, wherein the parameter for determining the first time period is based on whether there are ongoing periodic SSB transmissions when the indication is received.

24. The apparatus of claim 17, wherein the one or more processors are configured to cause the apparatus to transmit the one or more SSBs in a slot containing a candidate SSB resource that is first in time in an SSB burst, the SSB burst occurring at least the first time period after receiving the indication.

25. The apparatus of claim 17, wherein the one or more processors are configured to cause the apparatus to transmit the one or more SSBs in a slot used for SSB transmission first in time in an SSB burst, the SSB burst occurring at least the first time period after receiving the indication.

26. The apparatus of claim 17, wherein the one or more processors are configured to cause the apparatus to transmit the one or more SSBs within a second time period following the first time period.

27. The apparatus of claim 26, wherein the second time period corresponds to a number of slots, subframes, or frames.

28. The apparatus of claim 26, wherein the second time period is based on a periodicity associated with SSB transmissions including the one or more SSBs.

29. A method for wireless communications at a user equipment (UE), comprising:
transmitting, to a network entity, capability information indicating a parameter for determining a first time period associated with a synchronization signal block (SSB) transmission;
receiving, from the network entity, an indication of the SSB transmission; and
monitoring for the SSB transmission to receive one or more SSBs in accordance with the indication, wherein the one or more SSBs are to be received at a time instance that is after at least the first time period following receiving the indication.

30. A method for wireless communications at a network entity, comprising:
receiving, from a user equipment (UE), capability information indicating a parameter for determining a first time period associated with a synchronization signal block (SSB) transmission;
transmitting, to the UE, an indication of the SSB transmission; and
transmitting one or more SSBs in accordance with the indication, wherein the one or more SSBs are to be transmitted at a time instance that is after at least the first time period following transmitting the indication.
